(19) United States
(12) Patent Application Publication
(10) Pub. No.: US 2014/0246133 A1
(43) Pub. Date: Sep. 4, 2014

(54) TIRE CONTAINING A COMPONENT FOR REDUCING VIBRATION-GENERATED NOISE IN A TIRE AND METHOD FOR REDUCING TIRE NOISE

(71) Applicant: E I DUPONT DE NEMOURS AND COMPANY, Wilmington, DE (US)

(72) Inventors: MARK ALLAN LAMONTIA, Landenberg, PA (US); Geon-Seok Kim, Wilmington, DE (US)

(73) Assignee: E I DU PONT DE NEMOURS AND COMPANY, Wilmington, DE (US)

(21) Appl. No.: 13/783,679

(22) Filed: Mar. 4, 2013

(51) Int. Cl. B60C 19/00

(52) U.S. Cl. CPC B60C 19/002
USPC 152/151; 156/110.1

(57) ABSTRACT

This invention pertains to a tire having a plurality of vibration absorbers wherein, (i) the vibration absorbers have at least one spring element and at least one absorber mass element, each element having a first and second surface such that the first surface of the spring element is attached to the tire carcass or attached to or embedded into the tire inner liner, and (ii) the first surface of the absorber mass element is attached to the second surface of the spring element, or the absorber mass element is embedded into the spring element.

### BACKGROUND

1. Field of the Invention

This invention pertains to a component for reducing vibrational noise in vehicle tires.

2. Description of Related Art

A tire exhibits multiple structural resonances as well as acoustic cavity resonances. Low frequency tire structural vibration modes transmit excessive vibration energy to the vehicle and create low frequency noise in the cabin. In particular, the first vertical mode, usually below 100 Hz, is known to be a dominant road noise source. Many high-frequency structural modes cause tire surface vibrations and generate air-borne noise. Tires also have resonances in the air cavity that exist at around 200 Hz to 250 Hz for passenger tires.

U.S. Pat. No. 7,669,628 to Yukawa describes a method for manufacturing a pneumatic tire having a noise damper, in which the noise damper can be fixed to the inner surface of the tread portion by the use of a double-sided adhesive tape. The noise damper is made of a sponge material having a 0.005 to 0.060 specific gravity.

U.S. Pat. No. 7,188,652 to Yukawa teaches a tire comprising a plurality of small noise dampers disposed in the tire hollow and secured to an inner surface of a tread portion, each damper being made of a sponge-like multi-cellular material, wherein the total noise damper volume is 0.4 to 20% of the tire cavity volume.

United States Patent Publication 2007/0085251 to Masami et al discloses a tire comprising a damping alloy member embedded in one or more rubber portions of the tire.

U.S. Pat. No. 6,422,655 to Britton describes a sound absorber for insertion into a pneumatic tire composed of a support strip attached to the wheel rim on which the tire is mounted and a system or flexible fiber network attached to the mounting strip and extending in the radial tire direction.

U.S. Pat. No. 7,874,329 to Tanno discloses a low noise pneumatic tire where a plurality of noise absorbing members of a porous material is attached to the tire inner peripheral surface with intervals in the tire circumferential direction. The noise absorbing members number from 5 to 50. The total length obtained by integrating the noise absorbing member lengths in the tire circumferential direction is not less than 75% of the tire maximum inner peripheral length. The distance between each adjacent two of the noise absorbing members is equal to or greater than the maximum thickness of the noise absorbing members at the end portions thereof in the tire circumferential direction, while being not more than 15% of the tire maximum inner peripheral length.

All the patents listed above utilize acoustic foams to reduce cavity noise. They use acoustic energy dissipation in the foam, effective for cavity noise control. However, they do not affect the structural resonances that are the primary interior and exterior tire noise concerns. There is therefore a need to provide solutions to noise reduction arising from structural vibration as well as from cavity resonances in tires.

### SUMMARY OF THE INVENTION

This invention pertains to a tire comprising a plurality of vibration absorbers wherein,

(i) the vibration absorbers comprise at least one spring element and at least one absorber mass element, each spring and absorber mass element having a first and second surface such that the spring element first surface is attached to the tire carcass or embedded into the inner tire liner, and

(ii) the first surface of the absorber mass element is attached to the second surface of the spring element, or the absorber mass element is embedded into the spring element.

The invention also pertains to a method of decreasing tire generated noise.

### BRIEF DESCRIPTION OF THE DRAWINGS

FIG. 1 shows a vehicle tire cross-section as known in the art.

FIGS. 2 through 9 show cross-sectional views of embodiments of this invention.

FIG. 10 provides a view of a test fixture.

### DETAILED DESCRIPTION

The concept of the subject invention is a vibration absorber comprising a spring over a tire inner tread or side-wall structure having discrete mass elements on top of the spring. The spring is sometimes referred to as an elastic layer and the terms may be used interchangeably. The term elastic layer as used here encompasses both elastic and visco-elastic elastomers. In some other embodiments, sponge-like foams that have internal micro-cells may be used for the elastic layer. Any material can be used for the mass element as long as it can be accommodated in the tire manufacturing process. Rubber is preferred for the mass layer. Mass and elastic layers form distributed vibration absorbers that eliminate unwanted structural resonances. The elastic layer can provide a further benefit by also absorbing acoustic energy at a cavity resonant frequency. Such a concept is effective against structural noise as well as air-borne noise from tire tread and sidewall vibrations.

### Tire Components

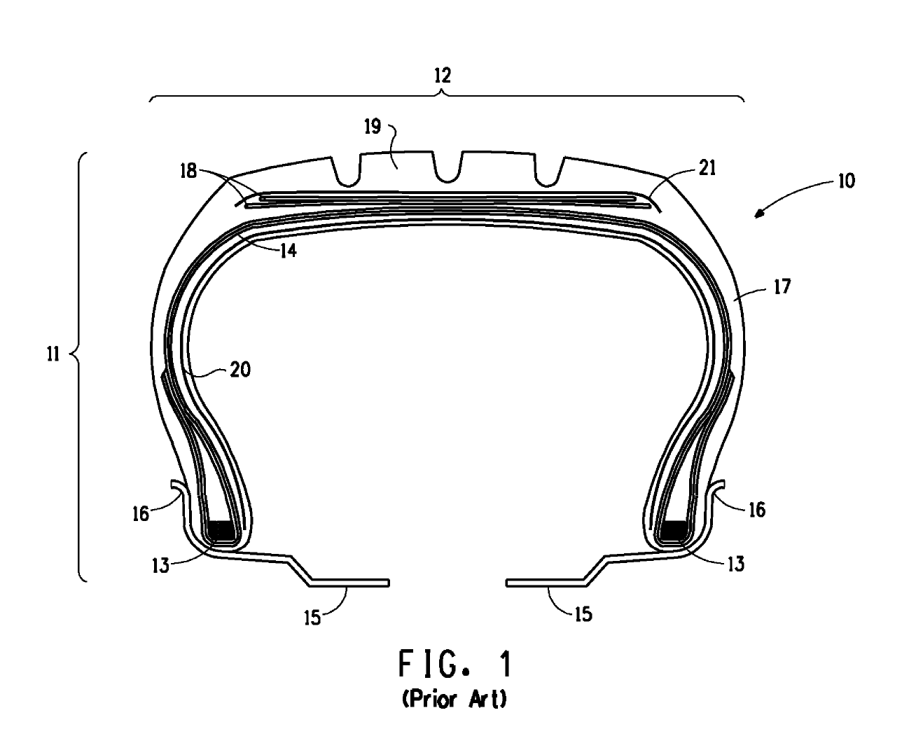

Shown generally at 10 in FIG. 1 is a cross-section of an automobile or truck tire comprising two principal sections, a sidewall section 11 and a crown section 12. A tire sidewall is the area between the tire bead 13 and the tread 19. Crown means that tire portion within the tire tread width limits. An inner liner 20 is a thin rubber layer or layers on the inside of the tire to contain the compressed air when the tire is inflated. Beads 13 are located where the tire sits on the rim flange 16. Bead means that tire part comprising an annular tensile member wrapped by ply cords and shaped, with or without other reinforcement elements such as flippers, chippers, apexes, toe guards, and chafers, to fit the wheel rim 15. Carcass means the tire structure apart from the belt structure, tread, undertread, and sidewall rubber over the plies, but including the beads. A carcass is sometimes called a casing. Carcass cords 14 provide tire strength and load bearing capabilities. The carcass cords are anchored by wrapping them around the bead wires 13. The carcass is positioned over the inner liner 20. A belt 18 is a narrow tire cord layer above the carcass in the tire crown. Belts are sometimes called breakers in truck tires. An overlay 21 is a layer or layers positioned above the belts 18 but below the tread 19. “Tread” means that tire portion that comes into road contact when the tire is normally inflated and under normal load. The sidewall rubber layer is shown at 17.

### Vibration Absorber

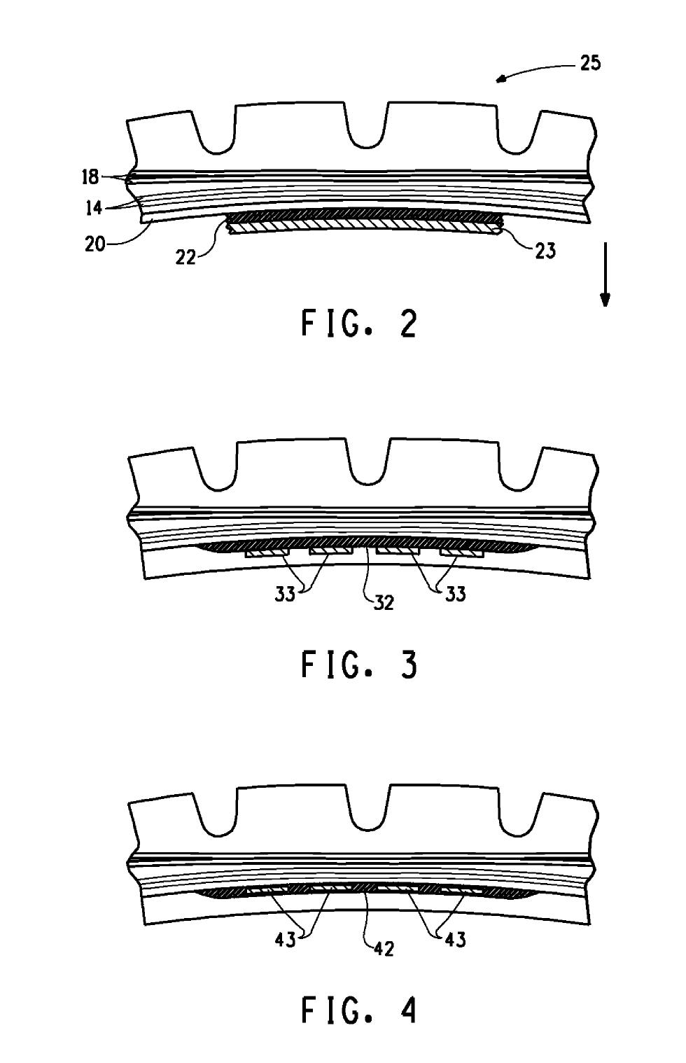

The vibration absorber of this invention comprises two elements. FIG. 2 shows a cross-sectional view of a tire portion comprising a carcass and a vibration absorber of this invention. A plurality of belt plies 18 are positioned above the carcass ply 14. A liner 20 is a thin layer of material, normally rubber that functions to contain air.

The vibration absorber comprises two elements, a spring element 22 and an absorber mass element 23.

The spring element comprises two principal surfaces, a first surface and a second surface. The first surface of the spring element is the surface closest to the tire inner liner. Surfaces other than the first and second surfaces of the spring element are considered to be edges of the spring element.

The absorber mass element comprises two principal surfaces, a first surface and a second surface. The first surface of the absorber mass element is adjacent to the second surface of the spring element. Surfaces other than the first and second surfaces of the absorber mass element are considered to be edges of the absorber mass element. The second surface of the absorber mass element is the innermost surface of the absorber and faces the internal tire cavity. The arrow in FIG. 2 points towards the internal tire cavity.

In some embodiments of the invention, the absorber mass element 23 is in contact with the spring element 22 as shown in FIG. 6A. In some other embodiments, the absorber mass element 23 is partially embedded into the spring element 22 as shown in FIG. 6B. In yet some other embodiments, the absorber mass element 23 is fully embedded into the spring element 22 as shown in FIG. 6C.

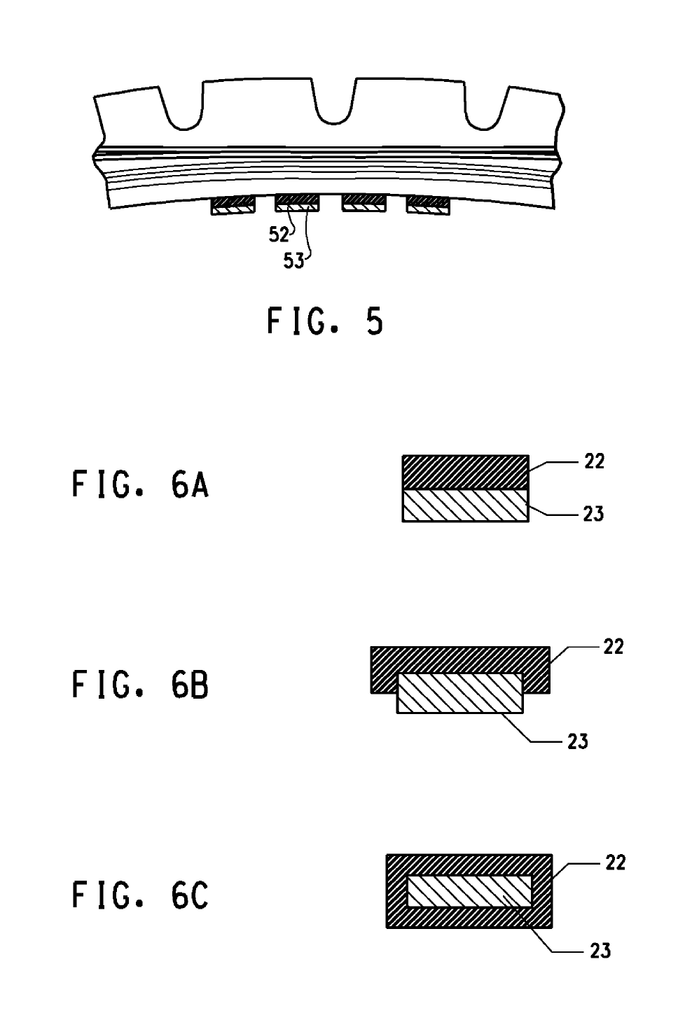

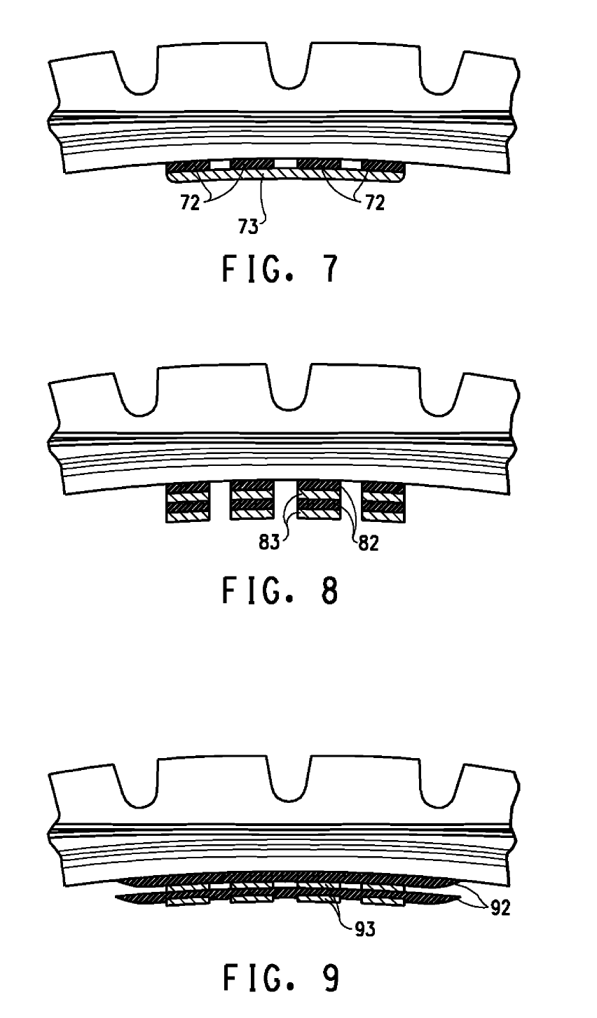

In one embodiment as in FIG. 3, a plurality of absorber mass elements 33 are attached to a single spring element 32. FIG. 4 shows a plurality of absorber mass elements 43 embedded into a single spring element 42. In another embodiment as in FIG. 5, a single absorber mass element 53 is attached to a single spring element 52. In yet another embodiment as in FIG. 7, a single absorber mass element 73 is attached to a plurality of spring elements 72.

Another aspect of this invention is shown in FIG. 8 wherein a plurality of spring elements 82 and a plurality of absorber mass elements 83 are stacked in an alternating sequence. The first spring element is attached to the inner liner or carcass. FIG. 9 also shows a plurality of spring elements 92 and a plurality of absorber mass elements 93 stacked in an alternating sequence. Other combinations are possible.

### Spring Element

The material selected for use as the spring element has an appropriate stiffness relative to the targeted natural frequency being eliminated. Preferably, the spring layer also should provide unchanged stiffness during the material lifetime to ensure stable performance. The shear strength of the absorber's spring layer can be important in applications where the spring layer has to support the weight of the discrete mass elements, once installed, either vertically or horizontally and against gravity. There should be no delamination, sagging, changing stiffness, or dimensional distortion. The spring element can comprise any material that provides flexibility to the absorbing mass. Examples of suitable material for use as the spring layer include open and closed-cell foams such as melamine, silicone, polyolefin and polyurethane foams, and various fibrous materials made from organic or inorganic fibers and combinations thereof. Polyethylene is a suitable polyolefin material. Other materials include films, polymer sheets, or any materials and structures that when coupled with a mass exhibit spring-mass resonance. A tire liner is an example of a suitable elastomeric block spring element. The spring layer can optionally include additional layers such as films, scrims, rubbers, membranes or metal layers. Suitable materials can also include a foam, a batt, an elastomeric block, a polymeric block, a sponge, a woven fabric, or a non-woven fabric. The foam may be an open or closed-cell foam and may be continuous i. e. one piece or discontinuous i. e. a plurality of pieces. A batt, or batting, is a soft bulky assembly of fibers, usually carded. Both natural and synthetic fibers or blends of both may be used to form the batt. Suitable fibers include hemp, jute, kenaf, cotton, cellulose, polyester, polyamide, glass, carbon, polyazole and polyolefin.

In the description of this invention, the term “elastomer” encompasses rubber and visco-elastic materials. The terms “rubber composition”, “compounded rubber” and “rubber compound” may be used interchangeably to refer to “rubber which has been blended or mixed with various ingredients and materials” and such terms are well known to those having skill in the rubber mixing or rubber compounding art.

The elastomers of the present invention include both natural and synthetic rubber compounds. Synthetic rubber compounds can be any that are dissolved by common organic solvents and can include, among many others, polychloroprene and sulfur-modified chloroprene, hydrocarbon rubbers, butadiene-acrylonitrile copolymers, chlorosulfonated polyethylene, fluoroelastomers, polybutadiene rubbers, polyisoprene rubbers, butyl and halobutyl rubbers and the like. Rubber mixtures may also be utilized. Other elastomers include, but are not limited to, natural rubber, butadiene rubbers, polyisoprene rubber (IR), styrene butadiene rubber (SBR), butyl and halobutyl rubbers (IIR, BIIR, CIIR), ethylene propylene rubbers (EPM, EPDM), crosslinked polyethylene (XLPE) and chloroprene rubbers (CR), nitrile rubbers (NBR), and mixtures thereof. Other suitable materials are neoprene, vinyl polybutadiene and viscoelastic polymers generally, such as thermoplastic polyester.

The spring element dimensions may be varied in order to absorb noises of different frequencies. Likewise, the spring element densities may also be varied in order to absorb noises of different frequency noisesies.

In one embodiment, the spring element dimensions match the average tread block length and width and are positioned on the inner liner in such a way so as to mirror the same spatial footprint as the tread block.

The inner spring layer and the associated masses form a distributed vibration absorber. The spring layer may be the inner tire layer. The inner layer may be continuous or discontinuous. The combination of the elastic layer, as a spring, and the absorbing masses form a distributed vibration absorber.

In some embodiments, the tire comprises a vibration absorber wherein the tire liner functions as the absorber spring element and at least one absorber mass element is attached to or embedded into the tire liner.

### Absorber Mass Element

The mass elements may be attached to the elastic layer by any known means such as adhesion or mechanical attachment, etc. They can also be embedded in the elastic layer or located between multiple adjacent viscoelastic layers. The discrete mass elements are preferably placed at the locations of relatively low effective modal mass for a given vibration mode. At nodal regions, where the motion for a particular mode is zero or very small, the effective modal mass becomes very large, and therefore, mass element placement at these locations would have little effect in reducing noise.

The absorber mass element can comprise any material that provides suitable mass and can be connected to a tire component surface. The mass elements can be all made from the same material or different materials. The mass element material is preferably noncorrosive or does not exhibit any other adverse effects in the environment in which the absorber will be used. It is desirable that the material is also compatible with other materials which it is in contact. The mass elements can have various shapes and sizes. The mass elements can conveniently be, for example, flat solid elements, disks, donut shapes, etc. The use of mass elements that provide absorber frequencies substantially equivalent to target natural frequencies present in a structure results in an absorber effective at absorbing the target vibration and/or noise emanating from the structure. Suitable materials include elastomers, rubbers, polymers, ceramics, metals, and alloys.

The absorber mass element dimensions may be varied in order to absorb different frequency noises. Likewise, the absorber mass element densities or the contact area between the mass elements and the tire may also be varied in order to absorb different frequency noises. In some embodiments, light and heavy masses may alternate either within a mass array or between mass arrays.

### Noise Reduction

Preferably, the mass and spring elements are selected such that they form a vibration absorber in which the absorber resonant frequency matches the noise frequency or frequencies to be eliminated.

### Yarns of the Carcass Ply and Belt Ply

The carcass plies and belt plies comprise yarns that may be made from aramid, polyester, rayon, or combinations thereof. Aromatic polyamide is a preferred fiber polymer. A preferred aromatic polyamide is para-aramid (p-aramid). A preferred polyester is polyethylene naphthalate (PEN). In some other embodiments, flame retarded polyester may be used. A preferred flame retardant polyester polymer is flame retardant polyethylene terephthalate (FR PET) or flame retardant polyethylene naphthalate (FR PEN). The use of such yarns in components for tires is well known in the art.

### Method of Reducing Noise in Tires

A method of decreasing noise generated by a tire may comprise the steps of

(a) identifying the troublesome noise frequencies,

(b) identifying the vibration mode or modes generating the noise,

(c) providing a vibration absorber comprising at least one spring element and at least one absorber mass element, each spring and absorber mass element having a first and second surface such that the first surface of the absorber mass element is attached to the second surface of the spring element, or the absorber mass element is embedded into the spring element,

(d) selecting the mass and spring elements such that the natural frequencies of the spring or absorber mass elements match the troublesome noise frequency or frequencies,

(e) attaching the first surface of the spring element to the carcass or tire inner liner with an orientation that is adapted to reduce noise based on the identified vibration mode or modes in step (b) or embedding the first surface of the spring element into the tire inner liner with an orientation that is adapted to reduce noise based on the identified vibration mode or modes in step (b),

(f) repeating steps (a) to (e) as required,

(g) assembling other tire components, and

(h) curing the tire.

### Production of Tires

The fixing of the mass element to a spring or the spring to the tread band or carcass can be achieved by in-situ adhesion during molding or by adhesion post tire fabrication.

There are three main stages in the production of a tire, namely component assembly, pressing, and curing. Any suitable rubber or elastomer may be used to make the tire. Further information on elastomer compounding is contained in pages 496 to 507 of The Vanderbilt Rubber Handbook, Thirteenth Edition, published by R. T. Vanderbilt Company Inc., Norwalk, Conn., and in U.S. Pat. Nos. 5,331,053; 5,391,623; 5,480,941 and 5,830,395.

In component assembly, a drum or cylinder is used as a tool onto which the various components are laid. During assembly, the various components are either spliced or bonded with adhesive. A typical sequence for layup of tire components is to first position a rubber sheet inner liner. Such a liner is compounded with additives that result in low air permeability. This makes it possible to seal air in the tire. The second carcass component is a layer of calendered body ply fabric (called a treatment) or cord coated with rubber and an adhesion promoter. Steel beads are applied over the carcass treatment and the liner ply is turned up. Beads are bands of high tensile-strength steel wire or synthetic fiber encased in a rubber compound and provide the strength to mechanically fit the tire to the wheel. Bead rubber includes additives to maximize strength and toughness. Next the apex is positioned. The apex is a triangular extruded profile that mates against the bead and provides a cushion between the rigid bead and the flexible inner liner and body ply assembly. This is followed by a pair of chafer strips and the sidewalls. These resist chafing from the wheel rim when the tire is mounted. The drum is then collapsed and the first stage assembly is ready for the second component assembly stage.

Second stage assembly is done on an inflatable bladder mounted on steel rings. The green first stage assembly is fitted over the rings and the bladder inflates it up to a belt guide assembly. Steel belts to provide puncture resistance are then placed in position. The belts are calendered sheets consisting of a rubber layer, a layer of closely spaced steel or synthetic fiber cords, and a second layer of rubber. The cords are oriented radially in a radial tire construction and at opposing angles in a bias tire construction. Passenger vehicle tires are usually made with two or three belts. The final component, the tread rubber profile of subtread and tread block layers, is then applied. The tread assembly is rolled to consolidate it to the belts and the finished assembly (green cover) is then detached from the assembly machine. The subtread can be formed by means well known to those skilled in the art. Tread can be formed in the tread block by means well known to those skilled in the art. Various grooves and designs are used in the trade to improve road grip, especially on wet, snow-covered, or ice-covered surfaces. Many higher-performance tires include an optional extruded cushion component between the belt package and the tread to isolate the tread from mechanical wear from the steel belts. If desired, the tire building process can be automated with each component applied separately along a number of assembly points.

Following layup, the assembly is pressed to consolidate all the components into a form very close to the final tire dimension.

Curing or vulcanizing of the elastomer into the final tire shape takes place in a hot mold. The mold is engraved with the tire tread pattern. The green tire assembly is placed onto the lower mold bead seat, a rubber bladder is inserted into the green tire and the mold closed while the bladder inflates to a pressure of about 25 kgf/cm². This causes the green tire to flow into the mold taking on the tread pattern. The bladder is filled with a recirculating heat transfer medium such as steam, hot water, or inert gas. Cure temperature and curing time will vary for different tire types and elastomer formulations, but typical values are a cure temperature of about 150° C. to 180° C. with a curing time ranging from 12 to 25 minutes. For large tires, the cure time can be much longer. At the end of the cure, the pressure is bled down, the mold opened and the tire stripped from the mold. The tire may be placed on a post-cure inflator that will hold the tire fully-inflated while it cools.

### TEST METHOD AND EXAMPLES

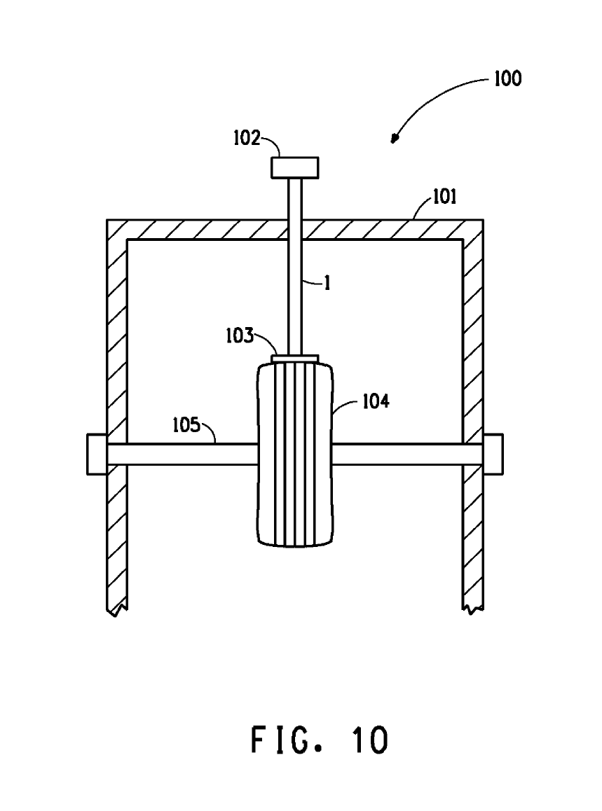

The test fixture is shown generally at 100 in FIG. 10 and comprises a frame 101, a Wilcoxon F3 0.75 lb shaker 102 and a PCB 208C02 force transducer (impedance head) 103. The transducer is attached to a tire 104, the tire being mounted on a wheel. A PCB 352C66 shear accelerometer 105 is attached to the wheel hub. The tire is subjected to a force perpendicular to the tread surface. A broadband random signal was applied through the shaker and the response was measured by the accelerometer. The transmissibility (acceleration/force) over a 50 to 500 Hz spectrum was measured through an OROS dynamic signal analyzer.

The tires used were Goodyear Assurance tires, model R205/65R15. The force transmissibility of two identical tires was measured to check the test variability and both tires gave a very close force transmissibility spectrum. There were two dominant peaks, the lowest peak occurring at 80 Hz and the other at 238 Hz. The 80 Hz peak is due to the structural (first vertical) mode and the 238 Hz peak is due to the tire's cavity resonance.

Thirty-seven vibration absorbers were attached circumferentially around the inside of the R205/65R15 tire crown. Each absorber, was spaced about 55 mm apart. The absorber comprised a melamine foam spring element 85 mm wide×2030 mm long×12.6 mm thick and a rubber block mass element 25.4 mm wide×25.4 mm long×19 mm thick. Each rubber block weighed 15.5 grams. Each absorber was designed to have an 80 Hz natural frequency. The melamine blocks were spray glued to the tire with 3M Super 77 spray adhesive from 3M, St. Paul, Minn. The total vibration absorber weight comprised 6.3% of the tire weight. Preferably, the vibration absorber weight does not exceed 10% of the tire weight. The force transmissibility/frequency test was repeated on the tire comprising vibration absorbers and a 19 db noise reduction was measured in the 80 Hz region. A reduction of 2 to 4 db was also noted for the 238 Hz cavity resonance which is sufficient to reduce vehicle interior noise. This demonstrates the effectiveness of the described vibration absorbers in reducing tire noise.

1. A tire comprising a plurality of vibration absorbers, wherein,
(i) the vibration absorbers comprise at least one spring element and at least one absorber mass element, each spring element and absorber mass element having a first and second surface such that the spring element first surface is attached to the tire carcass or embedded into the inner tire liner, and
(ii) the first surface of the absorber mass element is attached to the second surface of the spring element, or the absorber mass element is embedded into the spring element.

2. The tire of claim 1, wherein a plurality of absorber mass elements is attached to or embedded into a single spring element.

3. The tire of claim 1, wherein a single absorber mass element is attached to or embedded into a single spring element.

4. The tire of claim 1, wherein a single absorber mass element is attached to or embedded into a plurality of spring elements.

5. The tire of claim 1, wherein the spring element is selected from the group consisting of a continuous or discontinuous open or closed cell foam, a fibrous batt, an elastomeric block, a visco-elastic block, a rubber block or a polymeric block, a woven fabric, and a non-woven fabric,

6. The tire of claim 1, wherein the material of the absorber mass element is selected from the group consisting of rubber, elastomer, ceramic, metal, alloy and polymer.

7. The tire of claim 1, wherein a plurality of spring elements and a plurality of absorber mass elements are stacked in an alternating sequence.

8. The tire of claim 1, wherein the dimensions of the absorber mass elements are varied in order to absorb different frequency noises.

9. The tire of claim 1, wherein the absorber mass element densities or the area of contact between the mass elements and the tire are varied in order to absorb different frequency noises.

10. The tire of claim 1, wherein the spring element dimensions are varied in order to absorb different frequency noises.

11. The tire of claim 1, wherein the densities of the spring elements are varied in order to absorb different frequency noises.

12. The tire of claim 1, wherein the vibration absorbers are attached to or embedded in the tire inner liner and are positioned so as to mirror the same spatial footprint as the tread blocks.

13. A tire comprising a vibration absorber, wherein the tire liner functions as the absorber spring element and at least one absorber mass element is attached to or embedded into the tire liner.

14. A method of decreasing noise generated by a tire, comprising the steps of
(a) identifying the troublesome noise frequencies,
(b) identifying the vibration mode or modes generating the noise,
(c) providing a vibration absorber comprising at least one spring element and at least one absorber mass element, each spring and absorber mass element having a first and second surface such that the first surface of the absorber mass element is attached to the second surface of the spring element, or the absorber mass element is embedded into the spring element,
(d) selecting the mass and spring elements such that the natural frequencies of the spring or absorber mass elements match the troublesome noise frequency or frequencies,
(e) attaching the first surface of the spring element to the carcass or tire inner liner with an orientation that is adapted to reduce noise based on the identified vibration mode or modes in step (b) or embedding the first surface of the spring element into the tire inner liner with an orientation that is adapted to reduce noise based on the identified vibration mode or modes in step (b),
(f) repeating steps (a) to (e) as required,
(g) assembling other tire components, and
(h) curing the tire.

15. The method of claim 14, wherein the spring element is selected from the group consisting of the tire liner, a continuous or discontinuous open or closed cell foam, a fibrous batt, an elastomeric block, a visco-elastic block, a rubber block or a polymeric block, a woven fabric and a non-woven fabric.

16. The method of claim 14, wherein the absorber mass material element is selected from the group consisting of rubber, elastomer, ceramic, metal, alloy and polymer.
